(19) United States
(12) Patent Application Publication
(10) Pub. No.: US 2007/0261222 A1
(43) Pub. Date: Nov. 15, 2007

(54) Lateral Interface Device Extended Bladder

(76) Inventor: William Lepola, Magnolia, TX (US)

Correspondence Address: LAW OFFICE OF DAVID MCEWING, P.O. BOX 231324, HOUSTON, TX, 77023, US

(21) Appl. No.: 11/746,234

(22) Filed: May 9, 2007

Related U.S. Application Data
(60) Provisional application No. 60/798,909, filed on May 9, 2006.

(51) Int. Cl. B23P 6/00; B23P 19/04

(52) U.S. Cl. 29/402.01; 29/402.09; 29/402.21

(57) ABSTRACT

The invention subject of this disclosure is for an in situ pipe repair lateral interface device comprising a housing component comprising fluid inflation components and a bladder mounting flange and a housing extension fluid sealably attachable to the housing and containing a heatable and inflatable bladder that may be attached to the bladder mounting flange.

### RELATED APPLICATION

This application claims the benefit of and priority to provisional application No. 60/798,909, entitled Lateral Interface Device with Extended Bladder filed May 9, 2006. This application incorporates herein by reference the non provisional application of William Lepola entitled “Lateral Interface Device with Flexible Housing” filed May 9, 2007.

### BACKGROUND TO THE INVENTION

1. Field of Use

This application pertains to the in situ repair of the interface between an underground pipe and a lateral pipe.

2. Related Technology

Methods and devices for insitu repair of lateral interfaces include the patent issued to Tweedie U.S. Pat. No. 6,068,725 and Blackmore U.S. Pat. No. 7,073,536.

### SUMMARY OF DEVICE

An in situ pipe repair lateral interface device including a housing component comprising fluid inflation components and a bladder mounting flange. The device also includes a housing extension fluid sealably attachable to the housing and containing a beatable and inflatable bladder that may be attached to the bladder mounting flange.

### SUMMARY OF DRAWINGS

The accompanying drawings, which are incorporated in and constitute a part of the specification, illustrate preferred embodiments of the invention. These drawings, together with the general description of the invention given above and the detailed description of the preferred embodiments given below, serve to explain the principles of the invention.

FIG. 1 illustrates the bladder housing with the bladder eversion port, the housing extension and motor positioning mechanism.

FIGS. 2A and 2B illustrate the housing with a motor structure, including actuator bladders and skids that stabilize the unit within the main pipe.

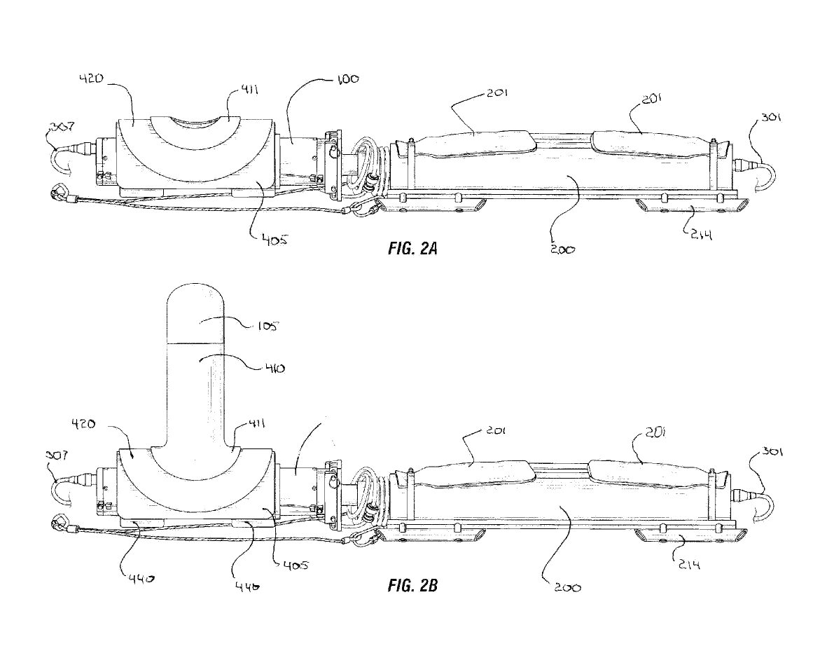

FIG. 3 is a perspective view of the housing with the everted bladder carrying the repair material. The motor structure is also shown.

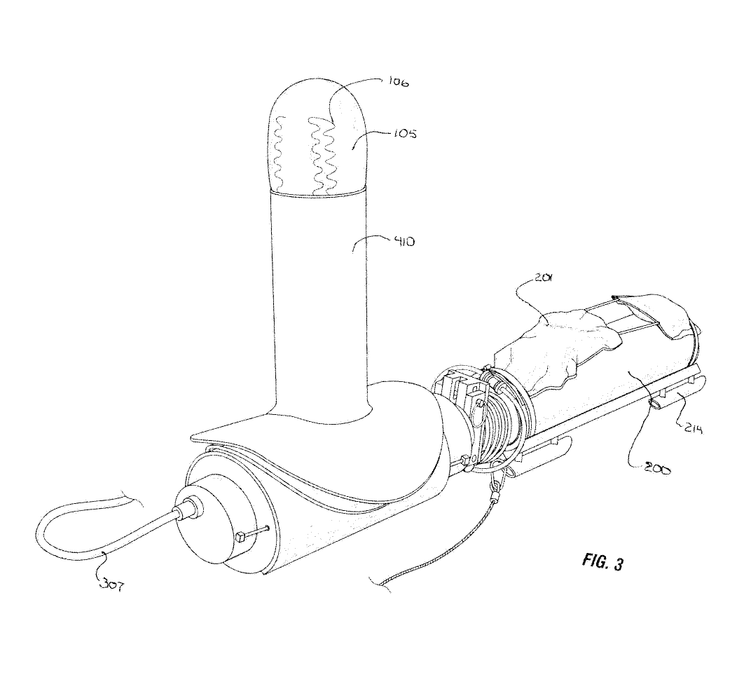

### DETAILED DESCRIPTION OF DEVICE

The device subject of the invention is for a lateral interface device wherein the everting bladder extends into the lateral pipe.

Bladders everting into a lateral line typically extend 8 to 12 inches. It will be appreciated that the bladder is inverted and stored within a housing structure of the lateral interface device during transportation and positioning. While stored, the bladder is in a deflated condition. The bladder may hold a resin impregnated repair liner. The length or size of the bladder is in part a function of the size of the housing. The housing component of the device must be dimensioned to fit within the interior space of the main pipe. It must also be dimensioned to fit within confined spaces such as non-linear pipe or constricted access through manholes, etc.

It is advantageous to install a pipe repair liner within a lateral pipe from a main pipe for a length greater than 8 to 12 inches. In the present invention, the bladder has an extended length permitting the eversion into the lateral pipe of more than 8 to 12 inches. It is envisioned that the method taught by this invention and the device described herein may permit repair bladders to be extended in excess of 5 feet into a lateral pipe. Longer lengths are envisioned. It will be appreciated that the bladder may be resistively heated to cure a repair liner installed with bladder within the lateral pipe.

To achieve transportation of the bladder (and lateral pipe repair material carried on the outer surface of the bladder), the housing of the device must be enlarged. The housing, however, must still be maneuverable within the constricted space of the pipe and access manholes. Accordingly, the housing (storing the deflated bladder) must be reconfigured to accommodate the larger bladder.

One change in the configuration of this invention may require that the fluid and electrical control components located in the housing are to be relocated from the front end of the housing to the back end proximate to the hinged junction with the motor structure.

In one embodiment of the invention, the device comprises a housing component (“housing”) that is removably attached to a motor structure (hereinafter “motor structure”). The motor structure provides controlled movement to the attached housing. The motor structure may contain motors for rotational, radial and longitudinal movement of the housing. Both the housing and the motor structure (together referred to as the “unit”) are dimensioned to fit within the interior of the main pipe (“pipe”). The unit may be generally cylindrical in shape and has a longitudinal axis of orientation.

There exist and are known to persons skilled in the technology multiple commercial manufactures of components that can be adapted as motor structures. For example the robotic cutter manufactured by Try Tek Machine Works, Inc., of Hanover, Pa. Other manufacturers of equipment that can be adopted to serve as motor structures include the Cues Kangaroo manufactured by Cues, 3600 Rio Vista Avenue Orlando, Fla., and the Bowman Cutter and Bowman Jumbo Cutter manufactured by Bowman Tool Co. In one embodiment, the housing of the invention can be interchangeably mounted and used with alternate motor structures.

The housing and the housing extension (hereinafter “housing extension”) are fluid sealable and contain the everting bladder carrying the repair material. There may be a connecting component between the housing and housing extension. The combination of the housing and housing extension contain fluid input and outlet mechanisms. One or both may contain electrical components to permit the heating of the bladder. Both the housing and extension are substantially inflexible or non-elastic in response to fluid pressure. Stated differently, the housing extension does not collapse under a vacuum or expand from internal fluid pressure. The housing extension is subjected to fluid pressure when the bladder is everted from the housing. The housing extension is subject to a vacuum when the fluid is evacuated as part of retraction of the bladder from the lateral pipe.

The housing and housing extension are preferably lightweight, abrasion resistant material. The housing extension is preferably longitudinally flexible or bendable in order that it may fit around bends or non-linear segments of the main pipe or may be inserted into the main pipe through the constricted space of a manhole access port. The housing extension holds a portion of the bladder and repair material during transportation to the juncture of the lateral and main pipe.

In an embodiment of the present invention, the housing extension comprises an extended cylindrically shaped length that may be detachably connected to the bladder eversion components of the housing. The modification may be considered to be a detachable extension to the housing. The housing extension may be equipped with skids or rollers to facilitate it being maneuvered through the main pipe.

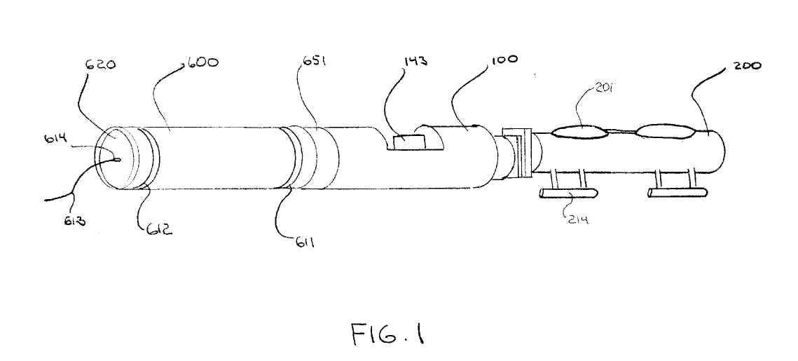

A perspective view of the device is illustrated in FIG. 1. The bladder storage housing extension 600 (“housing extension”) is mounted on the front end of the housing 100. Also shown is the bladder eversion flange 143 located as a component within the housing. (The flange is mounted at the eversion port of the housing and from which the inflating bladder everts out of the housing into the lateral pipe.) For clarity of illustration, the heating pad, actuator bladders, etc. are not shown on the housing. (It will be appreciated that these components are utilized in pressing and curing the repair liner to the main pipe.) The motor structure 200 is also illustrated.

The combined motor structure, housing and housing extension have a longitudinal axis The combined length of the device may be difficult to maneuver for the reasons stated. The motor structure may have a hinged relationship with the housing component. The housing extension is detachably mounted to the front end of the housing. The housing extension may also be bendable upon a radius. Also the multiple components housing extension, housing, and motor structure, may be assembled together at the access point to the main pipe.

In one embodiment, the extension 600 may be held (clamped or by thread or screw structure) to a connection component 651 (hereinafter “connecting component”) that may be connected to the front housing end. Other detachable fittings may be used e.g. cam and groove.

The connecting component may be a rigid component adapted to fit to the front end of the housing. It contains a first end and a second end and an internal annulus through which the everting bladder may pass through. The first end connects to the front end of the housing The connection is fluid sealable. It replaces the end cap component of the housing.

The second end of the connecting component may fit to the extension. In one embodiment, the extension comprises a 4 inch “rigid” rubber vacuum hose. The hose may have a bending radius of 12 inches. The extension may be 5 feet in length. The hose is vacuum rated (28″ Hg) and pressure rated 50 psi. The hose may be made of natural rubber, SBR, PVC reinforced with wire and/or fabric. It is temperature tolerant to 160° F.

The extension is cylindrically shaped with a 4 inch diameter. The extension also has a first end and a second end with an internal annulus. The deflated bladder (and repair material) will be stored within the extension. The first end of the extension fits over the connecting component.

The clamping mechanism 611, 612 may, in one embodiment, be low profile hose clamps or center-punch clamps. The clamps may preferably be stainless steel, corrosion resistant within a temperature range of 500° F. The hose fits over the connecting component. The clamp fits over the hose and secures the hose to the connecting component as illustrated in FIG. 1.

In one embodiment of the invention, the elongated everted bladder is controlled by a tether extending from the deployed end of the bladder to the front end of the extension. After the fluid pressure is removed (by vacuum or otherwise) the tether can be retracted into the housing and extension by pulling on the tether from a remote location. When the bladder is everted out of the housing in response to increased inflation pressure, a corresponding length of tether line will be pulled into the housing extension. The amount of tether line pulled into the housing extension may serve as a measure of the distance of the bladder everted (deployed) into the lateral pipe.

The second end of the extension is closed by a rigid end cap 620. The end cap fits into the extension and held in place (and fluid sealed) by a second clamp 612. The rigid end cap will have a fixed diameter. It may include a fluid sealable sealing gland 614, fluid tight cord grip. An example is a nickel plated brass liquid-tight cord grip that is corrosion resistant. This component may serve as a portal for the bladder control tether 613.

It will be appreciated that the extension may be removably attached to the housing. This can be accomplished by removal of a housing end cap (mechanically attached to the housing cylinder) and the extension coupling 651 being dimensioned and adapted to be mechanically attached in its place.

What we claim is:

1. An in situ pipe repair lateral interface device comprising:
a) a housing component comprising fluid inflation components and a bladder mounting flange; and
b) a housing extension fluid sealably attachable to the housing and containing a heatable and inflatable bladder that may be attached to the bladder mounting flange.

2. The device of claim 1 further comprising a flexible fluid sealable connection between the housing and the housing extension.

3. The device of claim 1 further comprising a motor structure having a hinged relationship to the housing and that positions and stabilizes the housing and housing extension within the pipe.

4. The device of claim 1 further comprising a connecting component between the housing component and the housing extension.

5. The device of claim 4 further comprising a hinged connecting component.

6. The device of claim 1 further comprising a tether attached to the end of the bladder for retracting the tether from a lateral pipe and further comprising the tether extending through the housing extension.

7. An in situ pipe repair lateral interface repair device comprising:
a) a housing component comprising fluid inflation components and electrical conductivity components and a bladder mounting flange; and
b) an inflatable and heatable bladder fluid sealably attached to the bladder mounting flange; and
c) a housing extension fluid sealably attachable to the housing and containing a portion of the inflatable and heatable bladder during storage and transportation of the bladder to a lateral interface.

8. A method of in situ repair of the interface between a main pipe and a lateral pipe comprising:
a. placing a repair material comprising a thermally responsive material onto a bladder;
b. inverting the bladder with the repair material into a housing and housing extension further comprising the housing and housing extension dimensioned to hold the bladder and repair material;
c. positioning the bladder within the housing utilizing a motor structure;
d. everting the bladder and repair material into a lateral pipe by adding fluid to the housing;
e. pressing the repair material to the lateral pipe;
f. resistively heating the bladder; and
g. retracting the bladder from the lateral pipe using a tether.

9. The method of claim 8 further comprising evacuating the fluid.

10. A device for the in situ repair of the interface between lateral pipe and main pipes comprising an inflatable and heatable bladder greater than 2 ft and less than 6 ft in length.

11. The device of claim 8 further comprising an inflatable and heatable bladder greater than 3 ft and less than 10 ft in length.
